(19) United States
(12) Patent Application Publication
(10) Pub. No.: US 2007/0065569 A1
(43) Pub. Date: Mar. 22, 2007

(54) LOW-CARBOHYDRATE POTATO PRODUCTS AND PROCESS

(75) Inventor: Randall S. Blaun, New York, NY (US)

Correspondence Address: THADDIUS J. CARVIS, 102 NORTH KING STREET, LEESBURG, VA, 20176, US

(73) Assignee: BLAUN INDUSTRIES, INC., New York, NY (US)

(21) Appl. No.: 11/420,586

(22) Filed: May 26, 2006

Related U.S. Application Data
(63) Continuation-in-part of application No. 10/317,530, filed on Dec. 12, 2002, now abandoned.

(51) Int. Cl. A23L 1/216

(52) U.S. Cl. 426/637

(57) ABSTRACT

Low-carbohydrate potato products include potato and cauliflower. Preferably, they are mixed together dry with a suitable water-dispersible or water-soluble binder. The dry mix can be prepared by mixing dried potato and dried cauliflower. A preferred form of the mix can be prepared for serving by mixing with water to provide a suitable consistency for final preparation, e.g., by simply heating or frying or baking. Potato products, especially those prepared from the dry mix and the above process are also described. Products that do not require shelf-stable storage do not require dry ingredients for their preparation and can be made from the indicated ingredients without drying by simply mixing the ingredients, e.g., potatoes and cauliflower, in their natural or cooked state.

### CROSS REFERENCE TO RELATED APPLICATION AND PRIORITY CLAIM

This application is a continuation in part of prior U.S. patent application Ser. No. 10/317,530, of the same title and by the same inventor, filed Dec. 12, 2002, the entire disclosure of which is hereby incorporated by reference.

### BACKGROUND OF THE INVENTION

The invention relates to potato products of modified formulation, which are especially suitable for people restrained to or desiring low-carbohydrate diets.

Nutrition and dietary factors play important roles in health promotion and chronic disease prevention. See, for example: 1) McGinnis J M, Foege W H. Actual causes of death in the United States. JAMA. 1993; 270:2207-2212; 2) Committee on Diet and Health, Food and Nutrition Board, Commission on Life Sciences, National Research Council. Diet and Health: Implications for Reducing Chronic Disease Risk. Washington, D.C.: National Academy Press; 1989; and 3) The Surgeon General's Report on Nutrition and Health. Washington, D.C.: US Dept of Health and Human Services; 1988 and DHHS (PHS) publication No. 88-50210. The Surgeon General's report states, “For two out of three adult Americans who do not smoke and do not drink excessively, one personal choice seems to influence long-term health prospects more than any other: what we eat.” (p 1).

People process foods differently and are faced with choices for health and self-image. Low-carbohydrate diets are available for many people who either cannot or choose not to consume large amounts of foods containing refined carbohydrates, such as sugars and carbohydrates. These diets are premised on the principal that excess carbohydrates are important factors for many for creating and storing large amounts of body fat.

Low-carbohydrate diets differ from those advocated by many traditional nutrition authorities who favor diets based on the so-called “food pyramid”, whose foundation rests on consumption of large amounts of high carbohydrate foods. The food pyramid lists foods without accounting for a need for restriction on carbohydrate intake. Thus, all fruits and vegetables and grains figure prominently in that view of a healthy diet. Low-carbohydrate diets, on the other hand, typically prohibit or severely limit all foods containing starches and sugars, including all grains, cereals, potatoes, and foods made with them. Allowed foods for a low-carbohydrate weight loss diet include meats, poultry, fish, shellfish, fats/oils, some dairy products (heavy cream, butter, and some cheeses), all green and other non-starchy vegetables, and a few other relatively low carbohydrate fruits.

Various people advocate certain variations to these criteria. For example, in U.S. Pat. No. 5,855,949, McLean advocates a low-carbohydrate, moderate-protein diet. He indicates that the patient should exclude all high starch products including cereals, breads, pastas (all flour products), rice, peas, corn, and potatoes. These products are said to have a high glycemic index, which stimulates the insulin-driven pathway. He also recommends excluding certain foods that he indicates are likely to counteract the effects of the dietary system of the his diet. Among others, he names soy and soy products, turnips, broccoli, cauliflower, Brussels sprouts, peanuts, and cabbage. These, he says have been shown to exhibit antithyroid activity in the body and are known to support the development of a hypothyroid system and resulting goiter. Typically, low-carbohydrate diets focus on reducing carbohydrates and do not stress calorie restriction.

There are also very significant differences between “low-fat” and “low-carbohydrate” diets. A diet simply restricting calories can reduce the intake of protein and fat and burns large amounts of both fat and muscle to provide fuel. These diets help an individual to lose weight, but may result in loss of muscle and reduction in basal metabolic rate. The result can be an increased need to cut calories.

On an effective low-carbohydrate diet, the body burns mostly fat and preserves lean muscle tissue. Exercise can add muscle while losing fat, thereby increasing a subject's basal metabolic rate, and enhancing the loss of fat. According to some studies, carbohydrates act very much like an addictive drug for some people. The more they eat, the more they crave those foods. On a low-carbohydrate diet, once past the initial few days, those cravings can significantly diminish, or disappear completely.

On an effective low-carbohydrate diet, the body burns mostly fat and preserves lean muscle tissue. Exercise can add muscle while losing fat, thereby increasing a subject's basal metabolic rate, and enhancing the loss of fat. According to some studies, carbohydrates act very much like an addictive drug for some people. The more they eat, the more they crave those foods. On a low-carbohydrate diet, once past the initial few days, those cravings can significantly diminish, or disappear completely.

There is a need for low-carbohydrate foods of greater variety than naturally occur to enable those on low-carbohydrate diets to eat many of the foods they are accustomed to but on the restricted or prohibited list. Among the needed new foods are low-carbohydrate potato products because people like potatoes, but they are essentially employed in conventional diets as a rich source of carbohydrates. To date, however, there are no known suitable low-carbohydrate potato products, dry mixes for their preparation or processes suitable to the task. It would be desirable to provide processing to assure the benefits to the widest range of individuals.

### DISCLOSURE OF INVENTION

Accordingly, it is an object of the invention to provide a low-carbohydrate potato product.

It is another object of the invention to provide a process for preparing a low-carbohydrate potato product.

It is another object of the invention to provide dry mix for preparing a low-carbohydrate potato product.

It is another object of the invention to provide processing to assure the benefits to the widest range of individuals.

It is another object of a preferred form of the invention to provide a process for preparing a low-carbohydrate potato product having minimal off-flavors and the product of that process.

These and other objects are realized by the present invention, which provides a low-carbohydrate potato product and a dry mix and process for preparing it.

One aspect of the invention comprises a dry mix for preparing a low-carbohydrate potato product, comprising: dried potato and dried cauliflower, preferably mixed together with a suitable water-dispersible or water-soluble binder. A preferred form of the mix can be prepared by mixing with water to provide a suitable consistency for final preparation, e.g., by simply heating or frying or baking.

In another aspect, the invention provides a process for preparing a low-carbohydrate potato product, comprising: mixing dried potato and dried cauliflower, together with a suitable water-dispersible or water-soluble binder, with an aqueous liquid in an amount sufficient to fully hydrate the dried potato, cauliflower and any binder or water-soluble ingredients to provide a suitable consistency for final preparation; and finally preparing the resulting mixture, e.g., by cooking.

Potato products, especially those prepared from the dry mix and the above process are also described. Products that do not require shelf-stable storage do not require dry ingredients for their preparation and can be made from the indicated ingredients without drying by simply mixing the ingredients, e.g., potatoes, in their natural or cooked state.

Other preferred aspects of the invention will be detailed below.

### DETAILED DESCRIPTION OF THE INVENTION

The invention will be described below with specific reference to preferred formulations and preferred processing techniques; however, it will be clear to the experienced food scientist that the principles that enable improvements in these will apply to other products as well, including frozen prepared products.

By the term “low-carbohydrate” is meant an amount of a food in a 100 gram serving which supplies less than about one fourth of the daily recommended intake of carbohydrate for a low-carbohydrate diet. Generally, a “low-carbohydrate diet” is defined as any diet that includes less than 100 grams of carbohydrate for an average person per day. Thus, all of the products of the invention will have carbohydrate in minor amounts, preferably in an amount of no more than 25 grams per serving. Preferably, the carbohydrate content is less than 15 grams per serving, e.g., 5 to 10 grams per serving.

The term “potato” is meant to include all of those starchy tubers typically identified as potatoes, including by way of example, Idaho, Russet, Kennebec, Russet Burbank, Idaho, Sebago, sweet, yam, and the like. The potato can be supplied in dried or wet form initially and then finally dried, if desired, for packaging. In the case of dried potatoes, they can be prepared by any suitable process, such as drum drying, spray drying, freeze drying, and the like. The potato ingredient of the invention will preferably be present at a level of from about 10 to about 50% by weight of dry solids in preferred formulations. This basis, i.e., weight of dry solids will be that used throughout the description, unless otherwise indicated. For food products containing other identifiable components, like hash which has a meat component, these and the following percentages will be based on the potato portion of the food.

The term “potato product” is meant to include all foods containing sufficient potato solids to provide a flavor identifiable as “potato” or “potato like” by a panel of expert tasters. An expert taster is a person trained to taste and objectively evaluate specific food flavors. The criteria for each evaluation are established and the sample size is selected to obtain determination of “potato” or “potato like” with a degree of confidence of at least 95%. It is an advantage that the products of the invention have a mealy, potato-like texture in addition to a potato flavor. This result is achieved by replacing a portion of the potato with lower carbohydrate, non-starchy foods, particularly cauliflower, in amounts effective to achieve a desired reduction in carbohydrate content while retaining potato flavor and texture in preferred formulations.

The term “cauliflower” is defined to mean a cauliflower component, which preferably contains cauliflower in principal proportion of this component, but can be supplemented with other like foods, including turnip, rutabaga and the like. The use of such materials can provide a suitable texture and flavor when properly compounded. The cauliflower will be used at level of from about 20 to about 50%. More typical ranges will be from about 25 to about 40% by weight. The cauliflower can be employed in some embodiments at a weight ratio to the potato of from about 1:3 to about 3:1. Preferred ratios tend to be within the narrower range of from about 2:3 to about 3:2.

In a preferred aspect, the invention modifies known processing for products of this type by processing the entire product or the cauliflower component to reduce any off-flavor that might be contributed by the cauliflower by at least 50% and preferably by at least 75% as compared to a product made with fresh, soft-cooked cauliflower not having been so treated. The off-flavor being one based on sulfur compounds associated by a panel of experts in cauliflower flavor as “cauliflowery”.

The products of the invention will also include one or more non-carbohydrate binder/filler components, preferably selected from the group consisting of: protein concentrates, protein salts, powdered cellulose, and the like. Cellulose and other such binder/filler components can have limited digestibility or be wholly non-digestible. Non-carbohydrate binder/filler components will preferably comprise from about 10 to about 60% by weight in preferred formulations. The binder/filler component can comprise one or more protein concentrates, such as those selected from the group consisting of calcium caseinate, egg whites, whey protein concentrate or isolate, soy protein concentrate or isolate, as well as pea, bean or other vegetable-protein isolates, and the like. In some preferred embodiments, a combination of calcium caseinate and dried egg whites, preferably essentially free of yolk, can be employed with the calcium caseinate being employed at a level within the range of from 10 to 40% by weight and the dried egg whites at a level of from about 6 to 30% by weight. The binder/filler component can be employed in some embodiments at a weight ratio to the potato of from about 1:2 to about 5:1. Preferred ratios tend to be within the narrower range of from about 2:3 to about 3:1. And, ratios of calcium caseinate to other binder/filler components can be within these same relative ranges. Indigestible fillers such as powdered cellulose can be employed at levels up to about 10% by weight, e.g., 1 to 5%.

In addition to the above ingredients, the low-carbohydrate foods and mixes of the invention can comprise a flavoring component comprising spices. Preferred among the various flavoring components are those which are available in dry form. Some of those preferred are onion, black pepper, celery, cinnamon, clove, cumin, egg yolk, garlic, milk, mustard, nutmeg, oregano, paprika, parsley, tomato, turmeric, and mixtures of at least two of these. Any other spices and vegetable products available in dry form can also be employed as long as they don't unduly increase the hygroscopicity of the composition. For example, in addition to black pepper, there are white pepper, various dried bell peppers, hot peppers of a number of varieties, and the like. Also various other spices can be employed as desired for taste. It is important that the various flavorings be capable of dry blending, so granular or particulate forms are desired. However, some materials are important also for their mouthfeel when hydrated or their visual impact and these factors will be taken into account for them. Salt is also preferred at suitable levels for good taste, e.g., up to about 2%, but can be reduced as desired. Salt substitutes can also be employed at suitable levels.

The compositions of the invention can also include suitable thickening agents, which will preferably be one or a combination which is easily hydratable and provides the mouthfeel desired for the final food product. Preferably, the thickening agent will comprise, in dry form, a member selected from the group consisting of flour, starch, vegetable gums and hydrocolloids, including xanthan gum, alginates, gelatin, pectin, and mixtures of at least two of these and substitutes or equivalents. The examples, which follow, will provide the skilled worker with guidelines as to materials and amounts.

The process of the invention entails mixing the ingredients in a manner that provides a uniform blend having the desirable textural properties. The process is exemplified below. In one aspect, the process for preparing a low-carbohydrate potato product utilizing the mix comprises: hydrating the mix; extruding the hydrated mix; cutting the extruded mix into strips of suitable size for frying as home fries, French fries and potato chips. Square or other cross sections are possible, including triangular, circular, rounded, rectangular, or the like.

Dimensions for French fries across the length will typically be in the range of from 0.10 to 1.0 inch and lengths of from 0.5 to 12 inches. More typically from 0.15 to 0.40 inch across and 1 to 6 inches in length. The product is cooked in a suitable manner, such as by frying, particularly, deep fat frying. Home fries are generally made smaller, but are generally processed in the same manner as the French fries.

The hydrated mix in the form of a dough can be formed into suitable chip shapes which can be deep fat fried to provide the potato chip products of the present invention. The sizes and shapes of the chips into which the dough can be formed are endlessly variable. A conventional potato chip made from a slice of raw potato can be very closely simulated by passing the dough between spaced mill rolls to form a sheet of dough ranging in thickness from about 0.005 inch to about 0.1 inch, and preferably from about 0.007 inch to about 0.02 inch. The dough sheet so formed can be cut into elliptical pieces having the approximate size and shape of sliced potatoes and then fried in conventional chip frying apparatus. Alternatively, apparatus such as that described in the co-pending application of Alexander L. Liepa, entitled “Method of and Apparatus for Preparing Chip-Type Products,” Ser. No. 683,083, filed Oct. 31, 1967, can be used to produce uniformly shaped chips. Chips should be heated to crispness, where they are essentially dry.

Typical of extruders are single screw extruders of the Braebender type, such as are widely used in the food industry, and double screw devices. Also, complex extruders can be effective.

In a preferred process the processing is altered from what might be the simplest form to include processing of the entire product or the cauliflower component to reduce off-flavor contributed by the cauliflower by at least 50% and preferably by at least 75% as compared to a product made with fresh, soft-cooked cauliflower not having been so treated. The off-flavor being one based on sulfur compounds associated by a panel of experts as “cauliflowery”.

The flavor improving processing can comprise one or more of the steps of freezing, moist heating, aging and/or drying in an amount sufficient to reduce the off-flavor contributed by the cauliflower by at least 50% and preferably by at least 75% as compared to a product made with fresh, soft-cooked cauliflower not having been so treated. Where the process relies upon aging, the product is preferably removed from the vessel used to contain it during agent and is then finally packaged. In some cases, vented packaging can be use for aging, followed by sealing the package.

Freezing the powdered dehydrated/freeze-dried cauliflower/potato blend (which has a one-year shelf life at room temperature unopened) for a period of time effective to significantly reduce off-flavors, e.g., for at least one month and preferably for from 3 to 6 months prior to preparation of products, which avoids contamination by microbes but allows sulfur compounds contained in the cauliflower to dissipate and neutralize. The process is preferably shortened by allowing the blend to “age” at room temperature for up to three months (as needed depending on initial processing method of the cauliflower).

Thoroughly pre-cooking the fresh cauliflower component of a subject cauliflower/potato blend, preferably after ricing, grating, mashing or otherwise subdividing to eliminate these same compounds, then blending with potato powder or fresh cooked potato to produce products that are then heated thoroughly by the customer.

Frozen prepared cauliflower/potato blend products such as potato pancakes prepared from the dry blend increase in “potato-like” flavor with prolonged freezing, up to six months or more.

An additional feature of the invention is that the above flavor-reducing processing can be employed without adversely affecting product nutrition. Tests have shown that neither cooking thoroughly nor freezing nor prolonged storage of the powder or finished products—“all-natural” methods of neutralizing the potentially offensive compounds—reduce the total amount of beneficial nutrients such as isothiocyanates, indoles such as indole-3-carbinol (I3c), the potent anticancer phytochemical sulphoraphane somewhat but not substantially, resulting in a product that is still rich in nutrients, including vitamin C, some protein, fiber and other micronutrients.

The flavor-reducing processing of the invention includes also flash freezing after cooking cauliflower and then dehydrating might work too for the powder.

Potato products, especially those prepared from the dry mix and the above process are also described. Products that do not require shelf-stable storage do not require dry ingredients for their preparation and can be made from the indicated ingredients without drying by simply mixing the ingredients, e.g., potatoes, in their natural or cooked state.

The following examples are provided to further illustrate and explain a preferred form of the invention and are not to be taken as limiting in any regard. Unless otherwise indicated, all parts and percentages are by weight.

### EXAMPLE 1

This example illustrates the preparation of a dry mix for preparing a low-carbohydrate potato product according to a preferred aspect of the invention. The following ingredients are prepared according to the process that follows.

| Ingredient | Parts by Weight |
|---|---|
| Potato powder | 22.5 |
| Dried cauliflower | 23.5 |
| Calcium caseinate | 22.2 |
| Dried egg whites | 20.5 |
| Onion powder | 7.0 |
| Sodium chloride | 2.0 |
| Saladizer 250 PH, gums | 1.5 |
| Ground black pepper | 0.8 |

The above ingredients are combined and blended in a V-blender until a uniform dry mix according to the invention is achieved.

### EXAMPLE 2

French Fries are prepared using the dry mix of Example 1, from the following ingredients and procedure:
½ cup Dry Mix of Example 1
¼ cup warm water
Vegetable oil or
   or vegetable spray for frying
1. Blend ½ cup mix with ¾ cup water in small bowl.
2. Coat nonstick skillet with vegetable spray or heat 2 tablespoons vegetable oil until hot.
3. Form 4 ½″-thick patties in skillet with spoon. Cook until lightly browned on both sides.
4. Remove patties from skillet; slice into 32-40 fries. Brown fries on all sides in small amount of additional oil or vegetable spray, or fry in deep fryer in oil heated to 360° F. for 1-2 minutes or until golden brown. Serves 4, approximately 8-10 fries per serving; 6 grams digestible carbohydrates (8 grams total carbohydrates, including fiber).

### EXAMPLE 3

Hash browns are prepared using the dry mix of Example 1, from the following ingredients and procedure:
½ cup Dry Mix of Example 1
¼ cup warm water
1 tablespoon each sauteed minced onion (optional)
   and sauteed minced green pepper (optional)
Dash salt and black pepper
Vegetable oil or
   vegetable cooking spray for frying
1. Blend Dry Mix of Example 1 and water in medium bowl.
2. Stir in onion (optional) and green pepper (optional).
3. Add salt and pepper.
4. Coat bottom of small skillet with vegetable oil or cooking spray and place on medium-high heat.
5. Place mixture in skillet and cook, turning continuously with spatula until lightly browned, around 2-3 minutes.

Serves 4; 6.5 grams digestible carbohydrate per serving (total carbohydrates 8.5 grams, including 2 grams fiber).

### EXAMPLE 4

Corned Beef Hash is prepared using the dry mix of Example 1, from the following ingredients and procedure:
½ cup Dry Mix of Example 1
5 oz. warm water
Vegetable oil
   or vegetable spray for frying
4 oz. lean canned corned beef, cubed
1. Blend Dry Mix of Example 1 with water in small bowl, stirring until smooth.
2. Place ¼″ of oil in 10″ non-stick skillet until hot, or coat skillet with vegetable spray and heat on medium-high.
3. Spoon batter into skillet, forming 4 ½″-deep patties. Cook 2-3 minutes or until golden brown on each side.
4. Remove patties from skillet onto plate. Cut into ½″ fries.
5. Place fries in pan and brown on all sides. Remove from pan and cut into cubes.
6. Return to pan and brown cubes on all sides. Add corned beef and stir together until lightly browned.

Serves 4, approximately ½ cup hash per serving; 8 grams digestible carbohydrates (10 grams total carbohydrates, including 2 grams fiber).

### EXAMPLE 5

Mashed Potatoes are prepared using the dry mix of Example 1, plus the following ingredients and procedure:
½ cup Dry Mix of Example 1
½ cup half-and-half, milk or water
1 tablespoon butter
½ teaspoon salt
Dash black pepper

Blend all ingredients in microwaveable bowl. Microwave on high for 2 minutes; fluffing with fork every 30 seconds. Fluff with fork and return to microwave for 1 minute. Stir again before serving. Serves 4; 6 grams digestible carbohydrates per serving if using water (8 grams total carbohydrates including fiber).

### EXAMPLE 6

Potato Pancakes are prepared using the dry mix of Example 1, from the following ingredients and procedure:
½ cup Dry Mix of Example 1
¾ cup warm water
1 egg yolk
½ medium onion (optional)
Vegetable oil or
   vegetable spray for frying

Processing
1. Blend water, egg yolk and onion in blender (if using onion, blend until onion is coarsely chopped). Blend in dry mix of Example 1.
2. Place ¼″ vegetable oil in 10″ skillet, or coat bottom of skillet with vegetable spray, and place on medium-high heat.
3. Place heaping tablespoonsful of mixture into skillet and cook 2-3 minutes. When edges bubble, turn over; cook 2-3 minutes until lightly browned. Makes 8 pancakes or 4 servings; 6 grams digestible carbohydrates per serving (8 grams total carbohydrates including 2 grams fiber).

### EXAMPLE 7

### Processing of Low-Carbohydrate Frozen French Fries

Processing
1. By weight combine 1 part dry powder mix with 1 part water.
2. Mix well to dough-like consistency.
3. Place dough in single-screw extruder (Brabender D=¾″; L/D=20)
4. Extrude through 0.40-inch square die at 60° C. and 150 rpm.
5. Cut with guillotine or other blade into 3-inch lengths.
6. Par fry at 390° F. for 5-10 seconds.
7. Cool, package and freeze.
8. Customer use: Deep-fry at 360° F. for about 1-2 minutes. OR toss with small amount of oil or coat with vegetable spray and bake at 425° F. for 10-12 minutes.

### EXAMPLE 8

### Alternative Processing of Low-Carbohydrate Frozen French Fries

Processing
1. By weight combine 1 part dry powder mix with one part water.
2. Mix well to dough-like consistency.
3. Force dough through sheeter to create ¼ inch sheet of mixture.
4. Roll sheet onto immersible fine mesh bed and cover with fine mesh screen.
5. Seal on all sides and par fry at 390° F. for 8 seconds. OR spray with oil on both sides and par bake.
6. Use grid cutter to cut sheet into ¼-inch×¼-inch″×3-inch fries.
7. Par fry for 3-5 seconds at 390° F.
8. Cool, package and freeze.

Customer use: Deep-fry at 360° F. for 1-2 minutes. OR toss with small amount of oil or coat with vegetable spray and bake at 425° F. for 10-12 minutes.

### EXAMPLE 1a

This example prepares a low carbohydrate potato mix as set out in Example 1 above, and then process it to reduce the level of cauliflower off-flavor by storing at freezer temperatures, e.g., from 0 to 25° F., for three months prior to preparation as set forth in the example. The resulting product is more potato like with less off flavor than the product of the noted earlier application.

### EXAMPLE 2a

French Fries are prepared using the dry mix of Example 1a, according to the process of Example 2. The resulting product is more potato like with less off flavor than the product of the noted earlier application.

### EXAMPLE 3a

Hash browns are prepared using the dry mix of Example 1a according to the process of in Example 3. The resulting product is more potato like with less off flavor than the product of the noted earlier application.

### EXAMPLE 4a

Mashed Potatoes are prepared using the dry mix of Example 1a according to the process of in Example 5. The resulting product is more potato like with less off flavor than the product of the noted earlier application.

### EXAMPLE 5a

Low carbohydrate potatoes are prepared according to Example 1a, but this time fresh cauliflower for the blend is thoroughly pre-cooked after ricing and then blending with potato powder to produce products that are then heated thoroughly by the customer. The resulting product is more potato like with less off flavor than the product of the noted earlier application.

### EXAMPLE 6a

Low carbohydrate potatoes are prepared according to Example 1a, but this time fresh cauliflower for the blend is thoroughly pre-cooked after grating and then blending with potato powder to produce products that are then stored frozen for thee months, repackaged, and finally heated thoroughly by the customer. The resulting product will be more potato like with less off flavor than the product of the noted earlier application.

The above description is intended to enable the person skilled in the art to practice the invention. It is not intended to detail all of the possible modifications and variations, which will become apparent to the skilled worker upon reading the description. It is intended, however, that all such modifications and variations be included within the scope of the invention which is defined by the following claims. The claims are meant to cover the indicated elements and steps in any arrangement or sequence which is effective to meet the objectives intended for the invention, unless the context specifically indicates the contrary.

1. A process for preparing a low-carbohydrate French fried potato, comprising: mixing dried potato and dried cauliflower, together with a suitable water-dispersible or water-soluble binder, with an aqueous liquid in an amount sufficient to fully hydrate the dried potato, cauliflower and any binder or water-soluble ingredients to provide a hydrated mixture suitable consistency for shaping into strips; and frying the strips to form a crisp French fry exterior.

2. A process according to claim 1, wherein the strips are formed by extrusion of the ingredients after hydration.

3. French fried potato products prepared by the process of claim 1.

4. A process according to claim 1, wherein the entire product or the cauliflower component is processed to reduce the off-flavor contributed by the cauliflower by at least 50% and preferably by at least 75% as compared to a product made with fresh, soft-cooked cauliflower not having been so treated.

5. A process for preparing a low-carbohydrate potato chip, comprising: forming a mix of hydrated ingredients by mixing dried potato and dried cauliflower, together with a suitable water-dispersible or water-soluble binder, with an aqueous liquid in an amount sufficient to fully hydrate the dried potato, cauliflower and any binder or water-soluble ingredients to provide a suitable consistency for final preparation; forming the hydrated mix of ingredients into a sheet; cutting the sheet into chips; and frying the chips.

6. Potato chips prepared according to the process of claim 5.

7. A dry mix for preparing French fried potatoes and potato chips, comprising: dried potato, cauliflower and a water-dispersible or water-soluble binder.

8. A dry mix according to claim 7, wherein a non-carbohydrate binder/filler component comprises from about 10 to about 60% by weight of dry ingredients.

9. A dry mix according to claim 7, wherein the potato ingredient is present at a level of from about 10 to about 50% by weight of dry solids.

10. A dry mix according to claim 7, wherein the cauliflower is used at level of from about 20 to about 50% by weight of dry solids.

11. A dry mix according to claim 7, wherein: the cauliflower is used at level of from about 20 to about 50% by weight of dry solids, the potato ingredient is present at a level of from about 10 to about 50% by weight of dry solids and a non-carbohydrate binder/filler component comprises from about 10 to about 60% by weight of dry ingredients.

12. A dry mix according to claim 11, wherein: the cauliflower is present at a weight ratio to the potato of from about 1:3 to about 3:1 and the binder/filler component is present at a weight ratio to the potato of from about 1:2 to about 5:1.

13. A dry mix according to claim 7, which contains from about 10 to about 50% potato, based on weight of dry solids, from about 20 to about 50% cauliflower based on weight of dry solids, and about 10 to about 60% binder, wherein the mix is capable of being cooked to prepare a food tasting like potatoes but having less than 25 grams of carbohydrate per 100 gram serving, and wherein the entire product or the cauliflower component is processed to reduce the off-flavor contributed by the cauliflower by at least 50% and preferably by at least 75% as compared to a product made with fresh, soft-cooked cauliflower not having been so treated, and wherein the processing includes one or more of the steps of freezing, moist heating, aging and/or drying in an amount sufficient to reduce the off-flavor contributed by the cauliflower by at least 50% and preferably by at least 75% as compared to a product made with fresh, soft-cooked cauliflower not having been so treated.

14. A process for preparing a French fried potato product by hydrating a mixture according to claim 13 to form a hydrated mixture, shaping the hydrated mixture, and frying the hydrated mixture to achieve French fry internal texture and a crisp exterior.

15. A French fried potato product prepared according to the process of claim 14.

16. A process for preparing a crisp potato chip product by hydrating a mixture according to claim 13 to form a hydrated mixture, shaping the hydrated mixture, and frying the hydrated mixture to achieve a crisp texture throughout.

17. A potato chip product prepared according to the process of claim 16.

18. A dry mix according to claim 13, wherein: the cauliflower is present at a weight ratio to the potato of from about 1:3 to about 3:1 and the binder is present at a weight ratio to the potato of from about 1:2 to about 5:1.

19. A French fried potato product prepared from the mix of claim 18.

20. A potato chip product prepared from the mix of claim 18.
